(19) United States
(12) Patent Application Publication
(10) Pub. No.: US 2012/0141832 A1
(43) Pub. Date: Jun. 7, 2012

(54) PERPENDICULAR MAGNETIC RECORDING MEDIA HAVING A DECOUPLED LOW ANISOTROPY OXIDE LAYER FOR WRITEABILITY ENHANCEMENT

(75) Inventors: Gunn Choe, San Jose, CA (US); Yoshihiro Ikeda, San Jose, CA (US)

(73) Assignee: Hitachi Global Storage Technologies Netherlands B.V., Amsterdam (NL)

(21) Appl. No.: 12/960,262

(22) Filed: Dec. 3, 2010

(51) Int. Cl. G11B 5/65; G11B 5/667

(52) U.S. Cl. 428/827

(57) ABSTRACT

A magnetic media having a multi-layer magnetic oxide structure with an uppermost magnetic oxide layer having a very low magnetic anisotropy energy. The magnetic oxide structure includes at least three magnetic oxide layers. An upper most magnetic oxide layer structure has a magnetic anisotropy energy of less than 1×10⁶ erg/cm³ and a saturation magnetization of greater than 300 emu/cm³. The magnetic oxide structure improves media magnetization in response to a magnetic field. The low anisotropy layer responds easily to a magnetic field. This magnetic response is then transferred to the underlying layers which have a higher magnetic anisotropy for improved robustness in maintaining magnetization over time and even in a high temperature environment.

### FIELD OF THE INVENTION

The present invention relates to magnetic heads for data recording, and more particularly to a low cost method for manufacturing a magnetic media having a pseudo onset layer for improved magnetic properties in the hard magnetic layer of the media.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

A giant magnetoresistive (GMR) or tunnel junction magnetoresistive (TMR) sensor senses magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current there-through. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

In a perpendicular magnetic recording system, the magnetic media has a magnetically soft underlayer covered by a thin magnetically hard top layer. The perpendicular write head has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

In order to optimize performance, the magnetic media must easily switch magnetization directions in response to a magnetic field from the write head. However, in order to be magnetically stable, these magnetizations must remain, even when the magnetic media is subjected to high temperature. In addition, in order to maximize data density, the magnetic media must be capable of recording very small, magnetically stable bits of data.

### SUMMARY OF THE INVENTION

The present invention provides a magnetic media for data recording having a magnetic oxide structure that includes a first magnetic oxide layer having a magnetic anisotropy energy of 4×10⁶ erg/cm³ to 1×10⁷ erg/cm³, a second magnetic oxide layer having a magnetization anisotropy energy of 3×10⁶ erg/cm³ to 5×10⁶ erg/cm³ formed over and in contact with the first magnetic oxide layer, and a third magnetic oxide layer having a magnetization anisotropy energy of less than 1×10⁶ erg/cm³ formed over and in contact with the second magnetic oxide layer.

The magnetic oxide structure improves media magnetization in response to a magnetic field. The low anisotropy layer responds easily to a magnetic field. This magnetic response is then transferred to the underlying layers which have a higher magnetic anisotropy for improved robustness in maintaining magnetization over time and even in a high temperature environment.

The magnetic media can also include an under-layer and pseudo onset structure formed beneath the magnetic oxide structure to improve the grain properties of the magnetic oxide layer. The under-layer can be formed of a non-magnetic metal such as Ru and the pseudo oxide layer (located directly over the under-layer) can be formed of the same non-magnetic metal as the under-layer, but in oxidized form. For example, the under-layer can be Ru and the pseudo onset layer can be RuOx.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an enlarged, cross sectional view of a portion of a magnetic media manufactured according to the present invention;

FIG. 3 is a graph showing a relationship between Hc and oxide thickness of three oxide layers in a magnetic media;

FIG. 4 is a graph showing a relationship between KV/kT and third oxide layer thickness;

FIG. 5 is a graph comparing SoNr of a magnetic media having a third oxide layer and a magnetic media without a third oxide layer;

FIG. 6 is graph showing a relationship between signal resolution and TAALF for magnetic media with a third oxide layer and without a third oxide layer;

FIG. 7 is a graph showing a relationship between minor loop slope and third oxide layer thickness; and

FIG. 8 is a graph comparing minor loop slope for a media with and without a third oxide layer.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

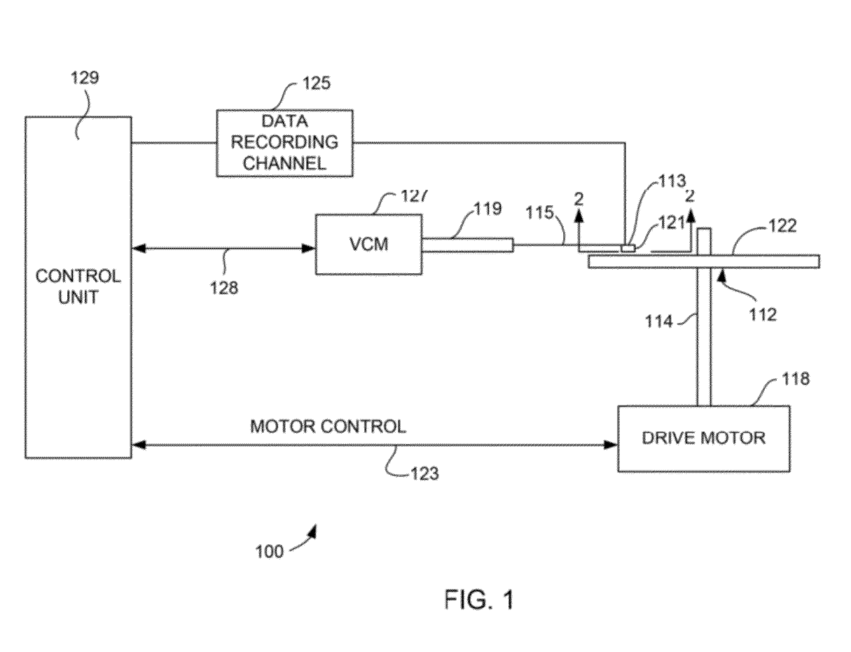

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, the slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

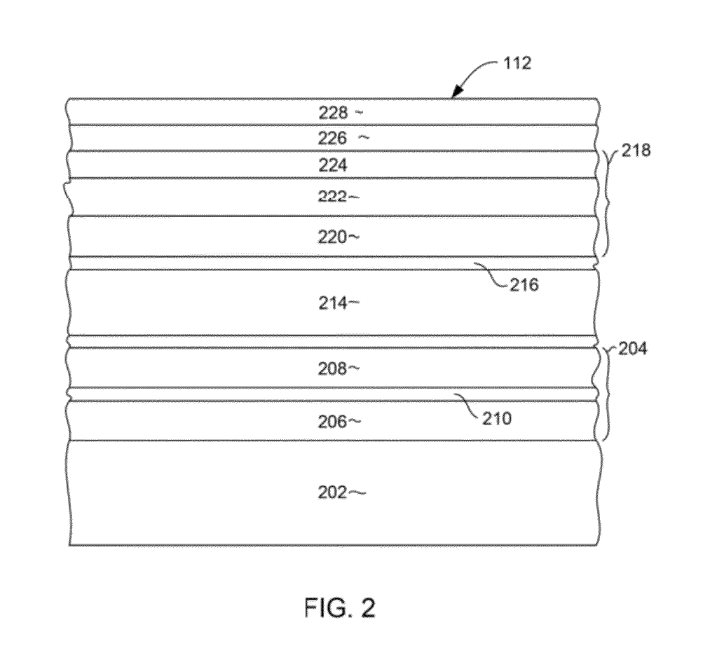

FIG. 2 shows an enlarged cross section of a magnetic media 112 for use in a perpendicular magnetic recording system. The media 112 includes a substrate 202, which can be a glass or an alumina metal alloy. A soft magnetic layer structure 204 is formed on top of the substrate 202. The soft magnetic layer structure can be an antiparallel coupled structure including first and second low coercivity magnetic layers 206, 208 such as CoFe, with a non-magnetic antiparallel coupling layer such as Ru 210 sandwiched there-between. A seed layer 212 is provided over the soft magnetic under-layer 204. The seed layer can be a material such as NiW, NiWCr or NiFeW, which is chosen to promote a desired grain growth on layers 214, 216, deposited thereon. A Ru under-layer 214 is then formed on the seed layer 212, and a pseudo-onset layer 216 is formed directly on top of the under-layer. As can be seen, the Ru under-layer 214 is substantially thicker than the pseudo-onset layer 216. The pseudo-onset layer 216 is constructed of Ru, like the under-layer 214, except that the pseudo-onset layer 216 has been oxidized whereas the under-layer 214 has not. This advantageously allows the pseudo-onset layer to be deposited in the same sputtering chamber using the same Ru target as that used to deposit the under-layer. This saves manufacturing time and complexity, and also allows both the under-layer 214 and the pseudo-onset layer 216 to be deposited using an older, less expensive sputter deposition tool having less chambers than a newer, more expensive sputtering tool.

The Ru under-layer 214 can be doped with a small amount of an element X, where X is one or more of Ti, Ta, B, Cr or Si. Similarly, the pseudo onset layer 216 can also be doped with a small amount of the element X, where X is one or more of Ti, Ta, B, Cr or Si. The pseudo onset layer 216 has the same composition as the under-layer, except for the addition of oxygen. The construction of the pseudo onset layer is discussed in greater detail in commonly assigned patent application Ser. No. 12/882,123 entitled METHOD FOR MANUFACTURING A MAGNETIC DATA RECORDING MEDIA HAVING A PSEUDO ONSET LAYER, filed on Sep. 14, 2010, which is incorporated herein by reference.

A hard novel magnetic oxide structure 218 is formed over the pseudo-onset layer 216. The hard magnetic layer structure 218 can include first, second and third magnetic oxide layers 220, 222, 224. The multi-layer hard magnetic structure 218 provides multiple magnetic oxide layers that have progressively lower magnetic anisotropy energies and progressively higher saturation magnetizations. The structure of the multi-layer structure 218 will be described in greater detail below.

A capping layer 226 is formed over the top of the hard magnetic multi-layer structure 218. The capping layer structure 226 can be, for example, CoFeB. A physically hard protective overcoat layer 228 can then be formed over the capping layer 226. The protective layer 228 can be a carbon overcoat, such as a layer of diamond like carbon (DLC).

With reference still to FIG. 2, the multi-layer hard magnetic structure 218 will be described in greater detail. In one embodiment of the invention, the first magnetic layer 220 can be constructed of a high magnetic anisotropy (high Ku) oxide such as Co—Pt—Cr—TiOx or Co—Pt—Cr—SiOx. The second layer 222 can be also be constructed of Co—Pt—Cr—TiOx or Co—Pt—Cr—SiOx, but at element proportions that cause the layer 222 to have a lower Ku value and higher saturation magnetization (Ms) than the first layer 220. The third layer 224 is a very low Ku, very high Ms layer. This layer 224 preferably has a saturation magnetization Ms that is greater than 300 emu/cm³, and can be constructed of Co—Cr—Ru—SiO or Co—Cr—Ru—CoOx.

The low Ku top oxide layer 224 is strongly exchange coupled with the second layer 222, and the second layer 222 is exchange coupled with the first layer 220. Because the top layer Ku has very low anisotropy energy Ku, it responds very easily to a magnetic field from a write head (not shown in FIG. 2). The layer 224, therefore, improves media writeability under a homogeneous field and angle of a recording head. The low Ku layer 224 responds readily to the presence of a magnetic field by changing its magnetization direction and then, because it is strongly exchange coupled with the underlying layer 222 it causes this layer's magnetization to switch accordingly as well. The magnetic orientation of the bottom layer 220 then switches in turn, in response to the magnetization of the layer 222. Because the layers 220, 222 have higher magnetic anisotropy energy (Ku), they can readily maintain their magnetizations after the magnetic field has been removed, thereby providing desired robustness.

The third oxide layer (very low Ku layer) 224 has a Ku of less than 1×10⁶ erg/cm³, very low Hk of 2-8 kOe, and a high saturation magnetization Ms value of greater than 300 emu/cm³. This oxide layer 224 can have 0-5 atomic percent Pt, 10-15 atomic percent Cr, 0-10 atomic percent Ru and 0-5 atomic percent of B, Ta, Si or Ti. Maintaining the combined concentration of Cr+Ru+B+Ti+Si at between 20 and 25 atomic percent ensures high Ms value of greater than 300 emu/cm³. The third oxide layer 224 has a Ku value that is ⅛ to 1/10 that of the high Ku first oxide layer 222. This low Ku third oxide layer 224 can be deposited by sputtering at a low pressure of about 5 mTorr, and preferably has a thickness of 5 to 20 Angstroms. While a primary role of the low Ku third oxide layer 224 is to create a high Ku grading in the oxide structure 218, a secondary role is to optimize oxide-to-cap (224/226) exchange coupling. For reduced magnetic spacing, the Ms of the third oxide layer 224 is high and a single layer cap 226 with an Ms, of 250-450 emu/cm³ is proposed instead of using an additional Exchange Coupling Layer (ECL) or write assist, multi-layered cap layers.

The third oxide layer 224 can be sputter deposited with SiO₂ and/or TiO₂ containing oxide targets or using a non-oxide containing target constructed of CoPtCrRu and one or more of B, Si, Ti and Ta and using an oxygen reactive sputtering method. Constructing the third oxide layer 224 to have a smaller Ku and larger Ms than the second oxide layer 222 optimizes recording performance. A primary role of the low Ku oxide layer 224 is to create very high Ku grading in the multi-layered oxide structure 218, and another roll is to optimize oxide-to-cap coupling. For reduced magnetic recording spacing, the Ms of the third oxide layer 224 is high, and a single layer capping layer 226 having a Ms of 350 to 450 emu/cm³ can be used instead of using an additional Exchange Coupling Layer (ECL) or write assisted multi-layer capping layer structure.

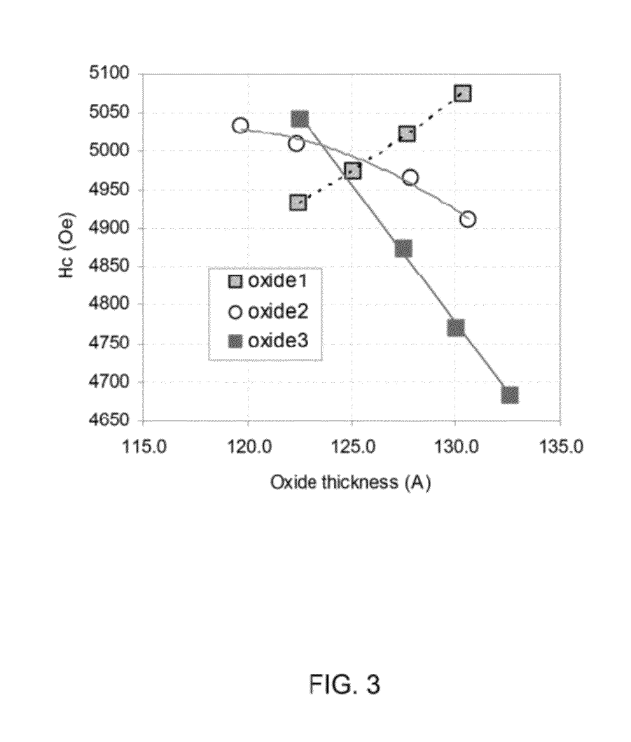

FIG. 3 shows the Hc change per thickness of each oxide layer 220, 222, 224 in the tri-layered oxide media with Ku grading [first oxide layer 220 (high Ku); second oxide layer 222 (low Ku); and third oxide layer 224 (very low Ku)] and indicates the relative degree of Ku difference among oxide layers. The third oxide layer 224 is strongly coupled to the second oxide layer 222 and controls the vertical exchange coupling to the cap layer 226 as well.

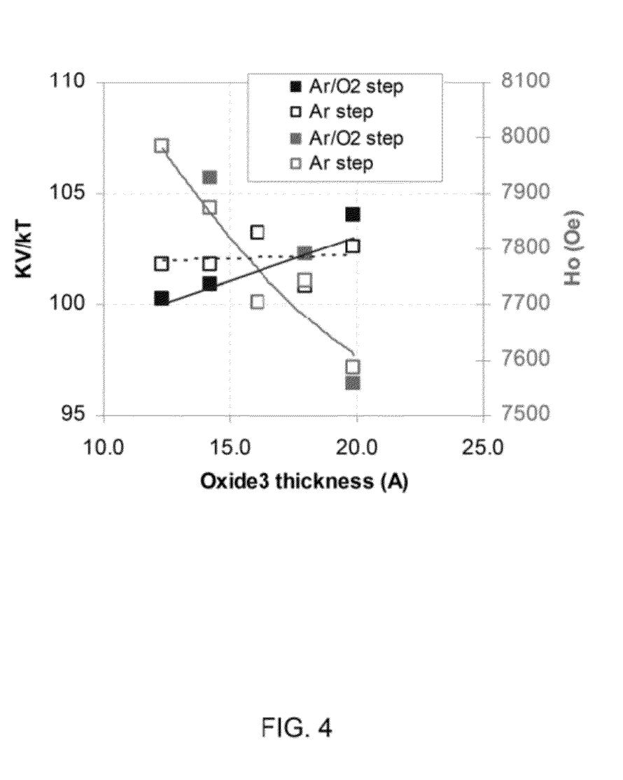

As shown in FIG. 4, with increasing thickness of third oxide layer 224, KV/kT increases and switching field at 1 nano-second, H_{O}. decreases. Thus, the presence of the very low Ku third oxide layer 224 enhances thermal stability and improves writeability.

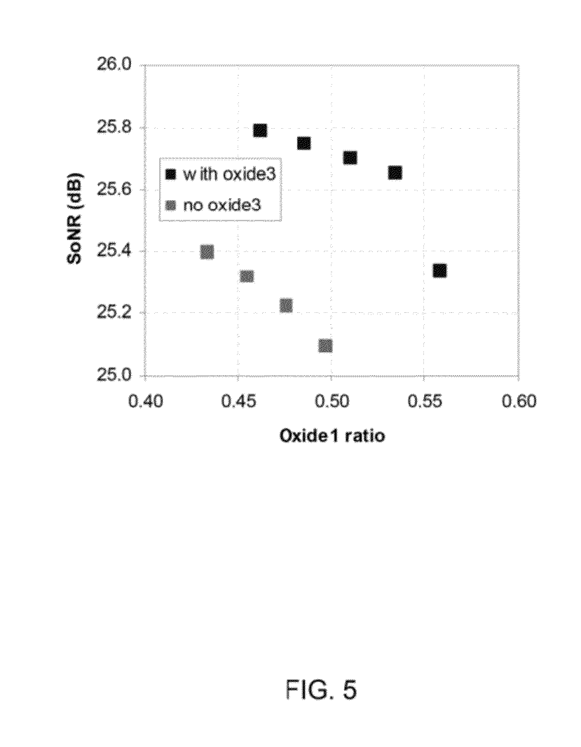

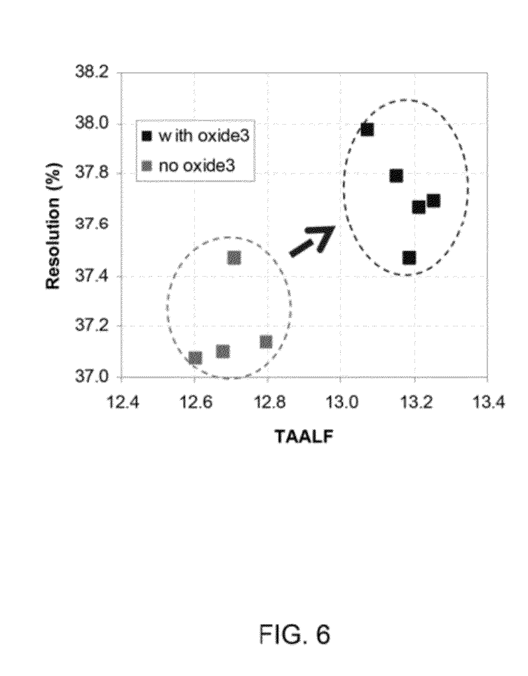

FIG. 5 shows the isolated signal-to 2T integrated media noise (SoNr) for media prepared with and without the third oxide layer 224 (FIG. 2) at various first oxide layer (220) to second oxide layer (224) thickness ratios. The SoNR of media with low Ku third oxide layer 224 is significantly higher than that of the media without the third oxide layer 224 over a wide range of ratios of first oxide layer 220 thickness to second oxide layer 222 thickness. As shown in FIG. 6, media with the low Ku third oxide layer 224 exhibits improved resolution and amplitude compared to media without the third oxide layer 224.

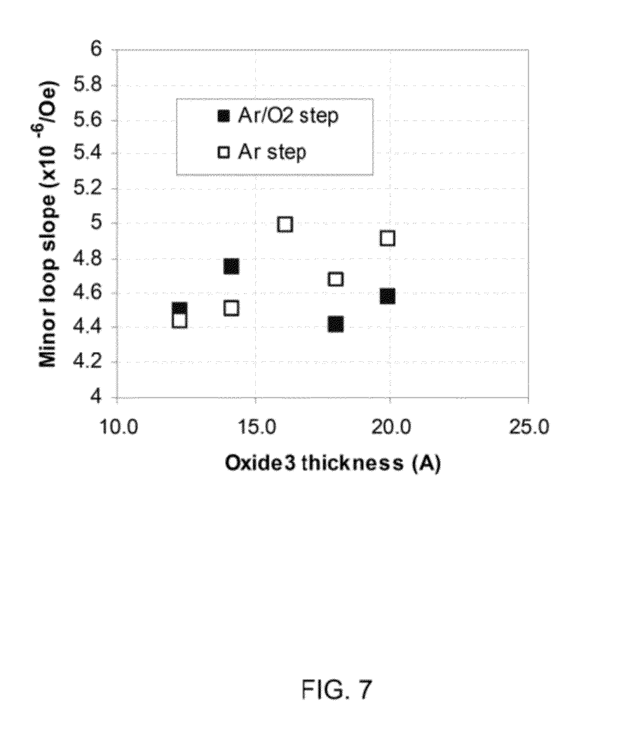

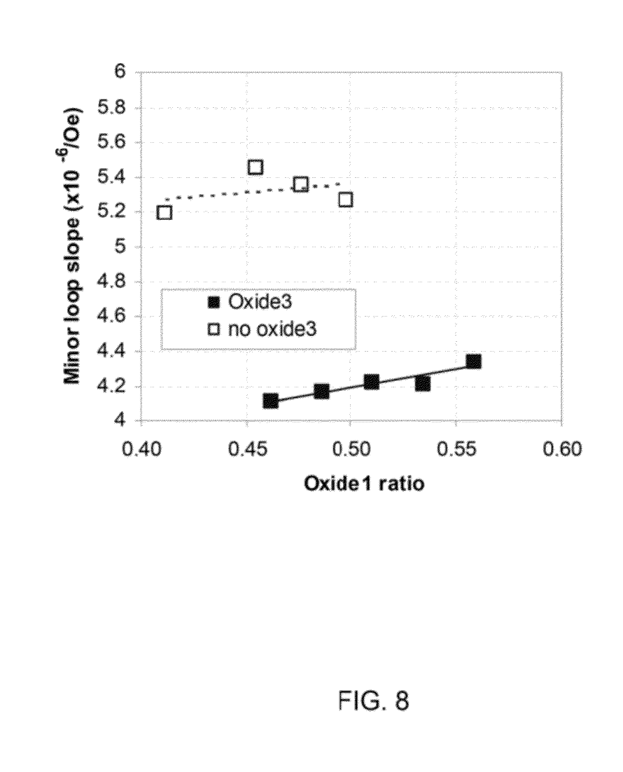

The intrinsic media switching mode of granular oxide is not affected by using the low Ku third oxide layer 224. FIG. 7 shows the switching mode analyzed using a minor loop slope method for media with varying thicknesses of low Ku oxide layer 224. The minor loop intensity representing degree of incoherent reversal mode doesn't change with increasing thickness of the third oxide layer 224. It was reported that when the cap layer 226 thickness increases or when the exchange coupling between the third oxide layer 224 and the cap 226 becomes strong, then more incoherent reversal is observed, which is not shown for the media with increasing thickness of oxide third oxide layer 224. The result of FIG. 7 strongly suggests that the low Ku third oxide layer 224 becomes a part of a multi-layered oxide with significant Ku grading. Further, the third oxide layer 224 is effective in modifying the strength of exchange coupling between the third oxide layer 224 and the cap 226. As shown in FIG. 8, minor loop slope of media with the third oxide layer 224 is lower than that of media without the third oxide layer 224, indicating that the third oxide layer 224 weakens the exchange coupling to the cap layer compared to the second oxide layer 222, resulting in a more coherent switching mode. As a result of this effect, media with a low Ku third oxide layer 224 show less cluster size than media without third oxide layer 224.

In order to optimize the recording performance of media with a low Ku third oxide layer 224, the composition of the third oxide layer 224 can be tuned by alloying the various elements (Co, Cr, Ru, Ti, Si, B, O). The Ku value of the third oxide layer 224 should be less than 1×10⁶ erg/cm³, whereas the Ku of first oxide layer 220 is preferably 4×10⁶-1×10⁷ erg/cm³ and the Ku of second oxide layer 222 is preferably 3×10⁶-5×10⁶ erg/cm³. For optimum exchange coupling between the third oxide layer 224 and the cap 226, the Ms of core grain in the third oxide layer 224 is preferably 300 emu/cm³ or greater, or can be 300-350 emu/cm³. Appropriate amounts of alloying non-magnetic elements including Ru, Cr, B, Ti in the Co-rich grain is effective in maintaining good crystallographic orientation as well as suitable inter-granular exchange coupling. The Pt concentration in the third oxide layer 224 can be zero to less than 10 atomic percent because the Ku value in the third oxide layer 224 is significantly lower than other oxide layers.

Although described as a tri-layer magnetic oxide structure 218, the magnetic oxide structure can also include more than 3 magnetic oxide layers, with each oxide layer having a lower Ku value than the magnetic oxide layer beneath it. Such a magnetic oxide structure 218 would have an uppermost oxide layer (e.g. 224) with a Ku less than 1×10⁶ emu/cm³.

While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic media for data recording, comprising:
a first magnetic oxide layer having a magnetic anisotropy energy of 4×10⁶ erg/cm³ to 1×10⁷ erg/cm³;
a second magnetic oxide layer having a magnetization anisotropy energy of 3×10⁶ erg/cm³ to 5×10⁶ erg/cm³ formed over and in contact with the first magnetic oxide layer; and
a third magnetic oxide layer having a magnetization anisotropy energy of less than 1×10⁶ erg/cm³ formed over and in contact with the second magnetic oxide layer.

2. A magnetic media as in claim 1 wherein the third magnetic oxide layer has a saturation magnetization of greater than 300 emu/cm³.

3. A magnetic media as in claim 1 wherein the third oxide layer comprises an alloy of Co, Pt, Ru and an oxide.

4. A magnetic media as in claim 3 wherein the oxide is SiOx or CoOx.

5. A magnetic media as in claim 1 wherein:
the first magnetic oxide layer comprises an alloy of Co, Pt, Cr and an oxide;
the second magnetic oxide layer comprises an alloy of Co, Pt, Cr and an oxide; and
the third magnetic layer comprises an alloy of Co, Pt, Ru and an oxide.

6. The magnetic media as in claim 1 wherein the oxide of the third magnetic layer is SiOx or CoOx.

7. The magnetic media as in claim 1 wherein the third oxide layer has a magnetic anisotropy field of 2-8 kOe.

8. The magnetic media as in claim 1 wherein the third oxide layer comprises an alloy of Co, Pt, one or more of Cr, Ru, B, Ti, Si, and an oxide.

9. The magnetic media as in claim 8 wherein the total content of Cr, Ru, B, Ti and Si is 20-25 atomic percent.

10. The magnetic media as in claim 1 wherein the third oxide layer comprises Co, Pt, Ru and an oxide, the oxide being SiOx or CoOx, and wherein the alloy contains less than 5 atomic percent Pt, 10-15 atomic percent Cr and less than 10 atomic percent Ru.

11. The method as in claim 1 wherein the third oxide layer is exchange coupled with the second oxide layer.

12. A magnetic media for data recording, comprising:
a soft magnetic structure;
a magnetic oxide structure;
an under-layer comprising a non-magnetic metal;
a pseudo onset layer formed over the under-layer, the under-layer and pseudo onset layer being located between the soft magnetic structure and the magnetic oxide structure;
the pseudo onset layer further comprising:
a first magnetic oxide layer having a magnetic anisotropy energy of 4×10⁶ erg/cm³ to 1×10⁷ erg/cm³;
a second magnetic oxide layer having a magnetization anisotropy energy of 3×10⁶ erg/cm³ to 5×10⁶ erg/cm³ formed over and in contact with the first magnetic oxide layer; and
a third magnetic oxide layer having a magnetization anisotropy energy of less than 1×10⁶ erg/cm³ formed over and in contact with the second magnetic oxide layer.

13. The magnetic media as in claim 12 wherein the pseudo oxide layer comprises an oxidized form of the non-magnetic metal of the under-layer.

14. The magnetic media as in claim 12 wherein the under-layer comprises Ru and the pseudo-oxide layer comprises RuOx.

15. The magnetic media as in claim 12 wherein the first magnetic oxide layer of the magnetic oxide structure contacts the pseudo onset layer.

16. A magnetic media as in claim 12 wherein the third magnetic oxide layer has a saturation magnetization of greater than 300 emu/cm³.

17. A magnetic media as in claim 12 wherein the third oxide layer comprises an alloy of Co, Pt, Ru and an oxide.

18. A magnetic media as in claim 17 wherein the oxide is SiOx or CoOx.

19. A magnetic media as in claim 12 wherein:
the first magnetic oxide layer comprises an alloy of Co, Pt, Cr and an oxide;
the second magnetic oxide layer comprises an alloy of Co, Pt, Cr and an oxide; and
the third magnetic layer comprises an alloy of Co, Pt, Ru and an oxide.

20. The magnetic media as in claim 12 wherein the oxide of the third magnetic layer is SiOx or CoOx.

21. The magnetic media as in claim 12 wherein the third oxide layer has a coercivity of 2-8 kOe.

22. The magnetic media as in claim 12 wherein the third oxide layer comprises an alloy of Co, Pt, one or more of Cr, Ru, B, Ti, Si, and an oxide.

23. The magnetic media as in claim 12 wherein the third oxide layer comprises an alloy of Co, Pt, one or more of Cr, Ru, B, Ti, Si, and an oxide.

24. The magnetic media as in claim 23 wherein the total content of Cr, Ru, B, Ti and Si is 20-25 atomic percent.

25. A magnetic media for magnetic data recording, comprising:
a magnetic oxide structure having three or more magnetic oxide layers each oxide layer having a Ku value no greater than a Ku value of a magnetic oxide layer beneath it, the magnetic oxide structure having an uppermost magnetic oxide layer with a Ku value of less than 1×10⁶ erg/cm³ and a saturation magnetization of greater than 300 emu/cm³.
